(19) United States
(12) Patent Application Publication
(10) Pub. No.: US 2026/0285443 A1
(43) Pub. Date: Sep. 24, 2026

(54) SADDLE RIDING VEHICLE

(71) Applicant: HONDA MOTOR CO., LTD., Tokyo (JP)

(72) Inventors: Dai Ishizuka, Tokyo (JP); Masayuki Hiramaru, Tokyo (JP); Yukinobu Hazama, Aichi (JP)

(21) Appl. No.: 19/536,286

(22) Filed: Feb. 11, 2026

(30) Foreign Application Priority Data
Mar. 19, 2025 (JP) 2025-045795

(51) Int. Cl. B62M 9/16; B62K 11/04; B62K 25/24; B62K 25/28

(52) U.S. Cl. CPC B62M 9/16; B62K 11/04; B62K 25/24; B62K 25/28; B62K 25/286

(57) ABSTRACT

This saddle riding vehicle includes: a swing arm; a shaft provided on a rear portion of the swing arm; a bearing configured to hold the shaft; and a bearing holder configured to pivotably hold an axial center position of the bearing eccentrically with respect to the swing arm, in which the swing arm is provided with a slit where the bearing holder faces from the outside of the shaft in a radial direction, the bearing holder has a first scale in a circumferential direction that rotates around an axis of the shaft, the swing arm is provided with a second scale to correspond to the first scale around the slit, and the first scale faces from the slit.

### CROSS-REFERENCE TO RELATED APPLICATION

The present application claims priority based on Japanese Patent Application No. 2025-045795, filed Mar. 19, 2025, the content of which is incorporated herein by reference.

### BACKGROUND OF THE INVENTION

### Field of the Invention

The present invention relates to a saddle riding vehicle.

### Description of Related Art

In the related art, in a swing arm structure of a saddle riding electric vehicle, an endless chain is wound between a drive sprocket of a swing arm on the side of an internal combustion engine and a driven sprocket on the side of a rear wheel, and a driving force is transmitted to the rear wheel via the chain. For tension adjustment of this chain, a structure with an eccentric mechanism is known, as disclosed in Japanese Patent Publication No. H06-102436, for example, which includes a swing arm, a shaft provided on a rear portion of the swing arm, a bearing that holds the shaft, and a bearing holder that pivotably holds an axial center position of the bearing eccentrically relative to the swing arm.

### SUMMARY OF THE INVENTION

In a swing arm structure in the related art, since fastening members such as chains and bearing holders are disposed inside a rear wheel, it was difficult to check the condition of these fastening members, such as performing fastening work or checking the looseness of the fastening members, while visually checking the fastening members, without removing the rear wheel. In addition, Japanese Patent Publication No. H06-102436 discloses a scale that is installed on the side in the vehicle width direction, but it is difficult to check the scale while operating an eccentric mechanism due to the drive chain and the sprockets around the bearing holder, and there remains an issue with informing a user of an elongation amount of the chain.

An aspect of the present invention is directed to providing a saddle riding vehicle capable of easily checking an elongation amount of a chain.

In order to accomplish the above-mentioned objects, a saddle riding vehicle according to an aspect of the present invention employs the following configurations.

(1) An aspect of the present invention is a saddle riding vehicle including a swing arm (40); a shaft (30) provided on a rear portion of the swing arm (40); a bearing (54) configured to hold the shaft (30); and a bearing holder (53) configured to pivotably hold an axial center position of the bearing (54) eccentrically with respect to the swing arm (40), the swing arm (40) being provided with a slit (41) where the bearing holder (53) faces from the outside of the shaft (30) in a radial direction, the bearing holder (53) having a first scale (55) in a circumferential direction that rotates around an axis of the shaft (30), the swing arm (40) being provided with a second scale (42) to correspond to the first scale (55) around the slit (41), and the first scale (55) facing from the slit (41).

According to the aspect of the above-mentioned (1), the slit is provided in the part of the swing arm that holds the bearing holder, and by aligning the first scale provided on the bearing holder with the second scale provided around the slit, the rotation position can be read visually from the slit, making it easy to check the elongation amount of the drive transmission member such as a drive chain. In this way, in the present invention, the first scale is displayed in the circumferential direction of the bearing holder, making it easy to see the scale and perform adjustment work, especially when adjusting an eccentric shaft.

(2) In the aspect of the above-mentioned (1), the swing arm (40) may have a clamping portion (43) configured to fix the bearing holder (53), and an upper end of the clamping portion (43) may be provided below a lower end of the slit (41).

According to the aspect of the above-mentioned (2), since the upper end of the clamping portion is located below the slit, loosening and tightening operations can be easily performed without reducing the visibility of the slit.

(3) In the aspect of the above-mentioned (2), an upper end of the clamping portion (43) may be provided above a central axis of the bearing holder (53).

According to the aspect of the above-mentioned (3), since the upper end of the clamping portion is located above the central axis of the bearing holder, the clamping portion has good visibility and workability.

(4) In the aspect of the above-mentioned (2), an upper end of the clamping portion (43) may be provided above an axial center of the shaft (30).

According to the aspect of the above-mentioned (4), since the upper end of the clamping portion is located above the axial center of the shaft, the clamping portion has good visibility and workability.

(5) An aspect of the above-mentioned (1) or (2) may further have a wheel (31), and the slit (41) may be provided inside a peripheral edge of the wheel (31).

According to the aspect of the above-mentioned (5), by positioning the slit inside the peripheral edge of the wheel, the slit is prevented from being exposed to the outside, and the waterproof and dustproof effects inside the swing arm can be improved.

(6) In the aspect of the above-mentioned (1) or (2), the swing arm (40) may have a communication hole (47) communicating with the inside of the swing arm (40) below the bearing holder (53), and the bearing holder (53) may have a through-hole (53b) facing the communication hole (47).

According to the aspect of the above-mentioned (6), the communication hole provided below the swing arm and the through-hole provided below the bearing holder can allow an eccentric mechanism part to have a drainage function.

(7) An aspect of the above-mentioned (1) or (2) may further have a brake caliper (34), and the brake caliper (34) may be provided within a range below the slit (41).

According to the aspect of the above-mentioned (7), since the brake caliper is always disposed below the slit, the visibility of the slit can be ensured.

(8) In the aspect of the above-mentioned (2), a thick portion (40e) in a circumferential direction of the swing arm (40), which has thickness in the circumferential direction may be provided, and the thick portion (40e) may be provided with the clamping portion (43).

According to the aspect of the above-mentioned (8), increasing the rigidity of the thick portion of the clamping portion can prevent performance deterioration. Further, the bolt used for fastening can be disposed in the thick portion with high rigidity, and in combination with a bolt axial force, allows the bearing holder to be held efficiently and securely.

According to the aspect of the present invention, it is possible to easily check an elongation amount of the chain.

### BRIEF DESCRIPTION OF THE DRAWINGS

FIG. 1 is a right side view of a motorcycle according to an embodiment of the present invention.

FIG. 2 is a perspective view of the vicinity of a rear end portion of a swing arm of the motorcycle when viewed from an obliquely rear side.

FIG. 3 is an enlarged view of a main portion of the vicinity of the rear end portion of the swing arm shown in FIG. 2.

FIG. 4 is a bottom view of the vicinity of the rear end portion of the swing arm when viewed from a rear side.

FIG. 5 is a plan view of the vicinity of the rear end portion of the swing arm when viewed from above.

FIG. 6 is a cross-sectional view of the swing arm and a bearing holder when viewed in an axle direction.

FIG. 7 is a plan view of the vicinity of the rear end portion of the swing arm when viewed from above.

FIG. 8 is a plan view of the vicinity of the rear end portion of the swing arm when viewed from below.

FIG. 9 is a side view of the vicinity of the rear end portion of the swing arm when viewed from the right.

FIG. 10 is a perspective view of a bearing holder holding portion of the swing arm.

### DESCRIPTION OF EMBODIMENTS

Hereinafter, an embodiment of the present invention will be described with reference to the accompanying drawings. Further, in each embodiment described below, common parts are designated by the same reference signs. Directions of forward, rearward, leftward, rightward, and the like, in the following description are the same directions as in a vehicle described below unless the context indicates otherwise. In addition, in appropriate locations used in the following description, an arrow FR indicates the forward direction of the vehicle, an arrow LH indicates the leftward direction of the vehicle, an arrow UP indicates the upward direction of the vehicle, and a line CL indicates a lateral center of a vehicle body.

The term “intermediate” used in this embodiment includes not only a center between both ends of a subject, but also an inner range between both ends of the subject. In the following description, a vehicle body of a saddle riding vehicle is in an upright, stationary position with no tilt to the left or right and a steering angle of 0 degrees, and is in an empty vehicle state on the horizontal plane.

### Entire vehicle

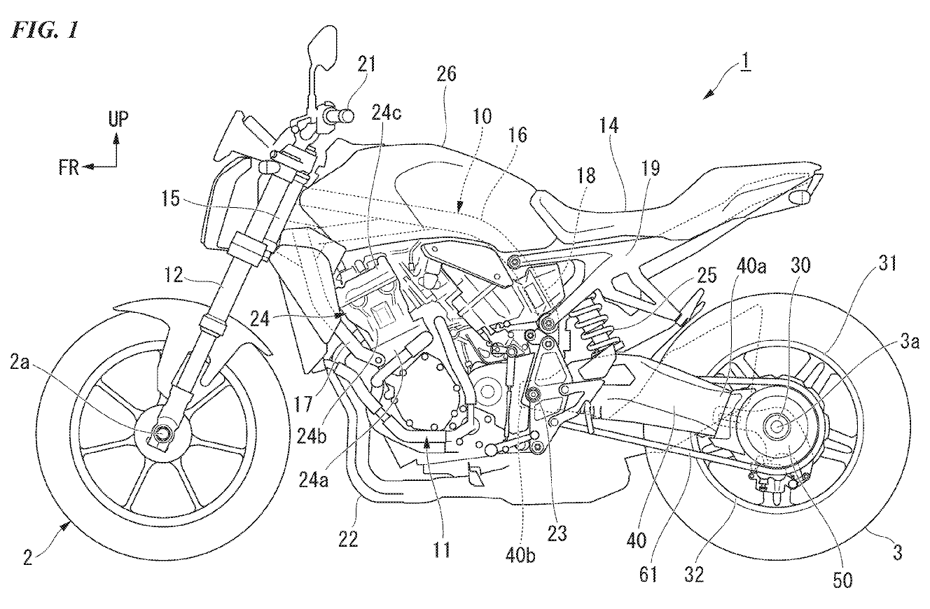

FIG. 1 shows a motorcycle 1 as an example of a saddle riding vehicle. FIG. 1 is a right side view of the motorcycle 1.

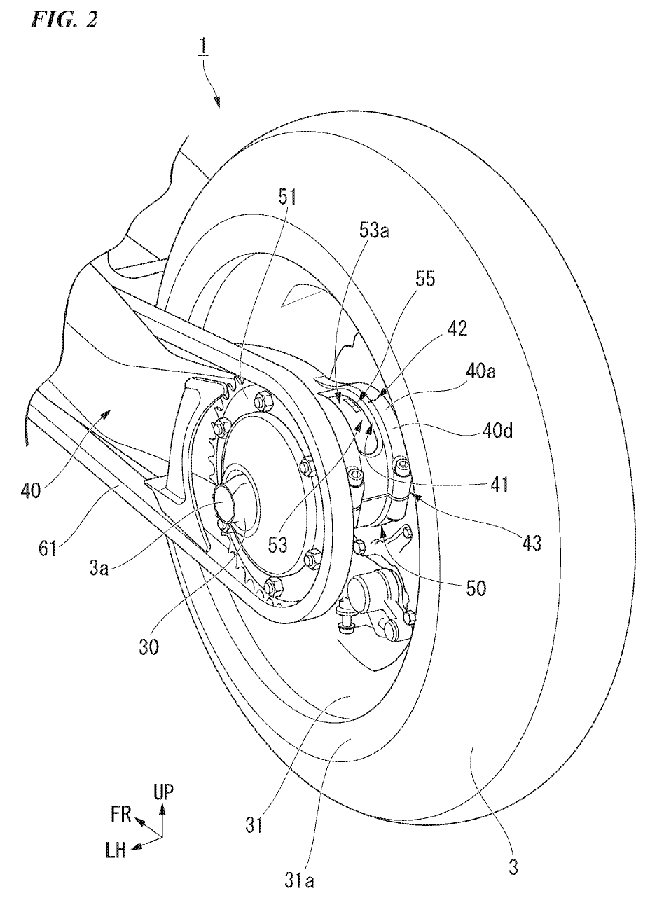

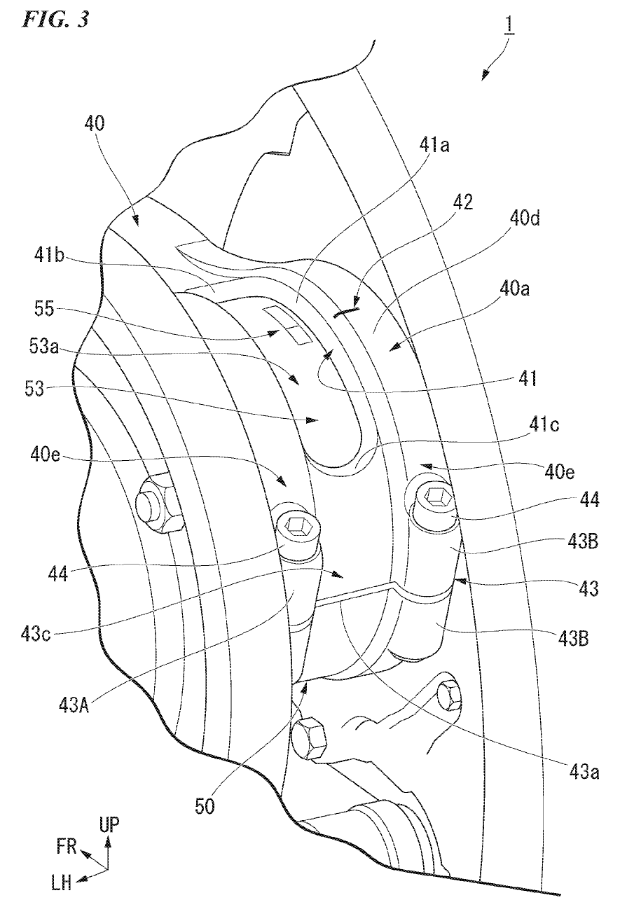

As shown in FIG. 1, the motorcycle 1 is a vehicle in which an internal combustion engine 11 is supported on a vehicle body frame 10, front forks 12 configured to steerably support a front wheel 2 steered by a handle 21 are steerably supported on a front end of the vehicle body frame 10, and a swing arm 40 configured to rotatably support a rear wheel 3 via a rear wheel support mechanism 50 (see FIGS. 2 and 3) is provided on a rear portion of the vehicle body frame 10.

The motorcycle 1 is a saddle riding vehicle in which an occupant sits astride a seat 14, which is provided above a rear portion of the vehicle body frame 10.

Steering system parts including the handle 21 and the front wheel 2 are steerably pivoted to a head pipe 15 formed in a front end portion of the vehicle body frame 10. The vehicle body frame 10 includes the head pipe 15 provided on a front end of the vehicle body frame 10, a main frame 16 extending rearward from the head pipe 15, a down frame 17 extending rearward and downward from the front end portion of the vehicle body frame 10, a center frame 18 extending downward from a rear end of the main frame 16, and a pair of left and right seat frames 19 extending rearward from an upper portion of the center frame 18.

The front forks 12 are supported by the head pipe 15 to be steerable left and right. The handle 21 for steering is attached to upper end portions of the front forks 12. The front wheel 2 is supported by an axle 2a provided on lower end portions of the front forks 12.

### Internal Combustion Engine

The internal combustion engine 11 is disposed below the main frame 16 and between the down frame 17 and the center frame 18 in a vehicle forward/rearward direction and fixed to the vehicle body frame 10.

The internal combustion engine 11 includes a crankcase (not shown), a crankshaft rotatably supported by the crankcase, and a cylinder portion 24 extending upward from an upper portion of a front portion of the crankcase. The crankcase is fixed to the vehicle body frame 10. The cylinder portion 24 includes a cylinder 24aextending upward from an upper surface of the crankcase, a cylinder head 24b joined to an upper surface of the cylinder 24a, and a head cover 24c configured to cover an upper surface of the cylinder head 24b. The internal combustion engine 11 is a multi-cylinder internal combustion engine in which multiple cylinders are arranged in the axial direction of the crankshaft. The crankshaft extends horizontally in the vehicle width direction (leftward/rightward direction), and the cylinders are disposed in a line in the vehicle width direction.

A rear portion of the crankcase is a transmission case portion that accommodates a transmission (not shown). Output of the internal combustion engine 11 is transmitted to the rear wheel 3 by a drive chain 61 that connects the transmission and the rear wheel 3.

An exhaust pipe 22 of the internal combustion engine 11 is drawn downward from the front surface of the cylinder head 24b, passes below the internal combustion engine 11 and extends rearward.

The seat 14 is disposed above the seat frames 19 and supported by the seat frames 19.

A fuel tank 26 is disposed between the seat 14 and the head pipe 15 above the internal combustion engine 11, and supported by the main frame 16.

### Rear Wheel Support Mechanism

The rear wheel support mechanism 50 is disposed on a left side of the rear wheel 3. The rear wheel support mechanism 50 includes a driven sprocket 51 meshed with a rear end portion of the drive chain 61, which is a drive transmission member, and fixed to an axle (hereinafter, referred to as a rear wheel axle 3a) of the rear wheel 3, a case 52 configured to accommodate the driven sprocket 51, and a bearing holder 53 having a bearing 54 configured to rotatably hold the rear wheel axle 3a. A front end portion of the drive chain 61 is connected to a drive sprocket (not shown) configured to output power by the internal combustion engine 11.

As shown in FIG. 2, the rear wheel axle 3a (a shaft 30) is hollow and rotatably

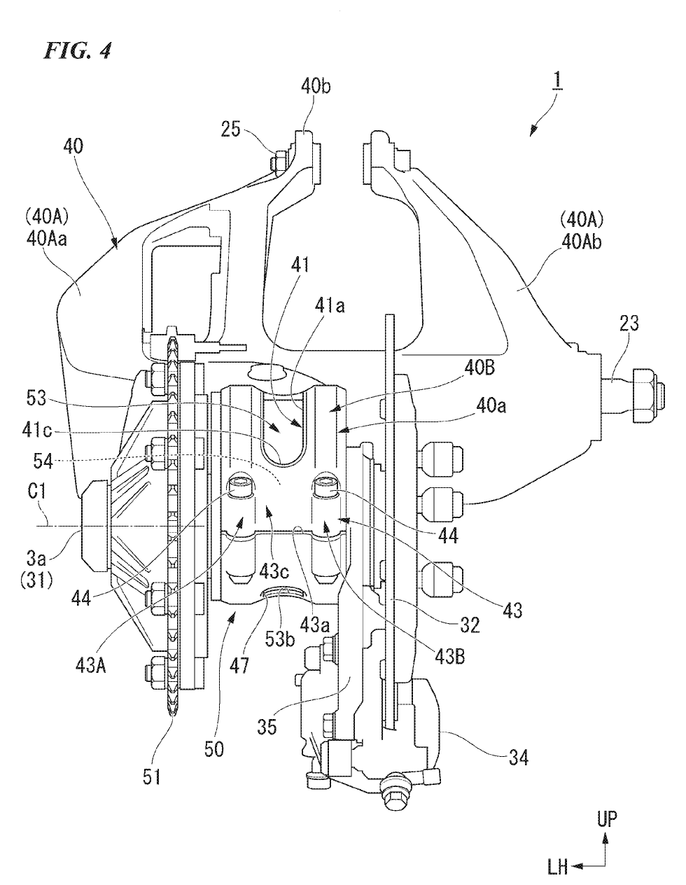

supports a wheel 31 of the rear wheel 3 as a drive wheel via the bearing 54, and as shown in FIG. 4, the driven sprocket 51 is fastened by a bolt to one side (left side) of the wheel 31 in the vehicle width direction, and a disc plate 32 is integrally provided on the other side (right side). A tire is fitted onto a rim 31a of the wheel 31.

As shown in FIG. 1, the drive chain 61 is wound endlessly between the drive sprocket on the side of the internal combustion engine 11 and the driven sprocket 51 on the side of the rear wheel 3, so that the power of the internal combustion engine 11 is transmitted to the rear wheel 3 via the drive chain 61.

A brake bracket 35 to which a brake caliper 34 is attached can move back and forth following the pivot of the eccentric mechanism.

### Bearing Holder

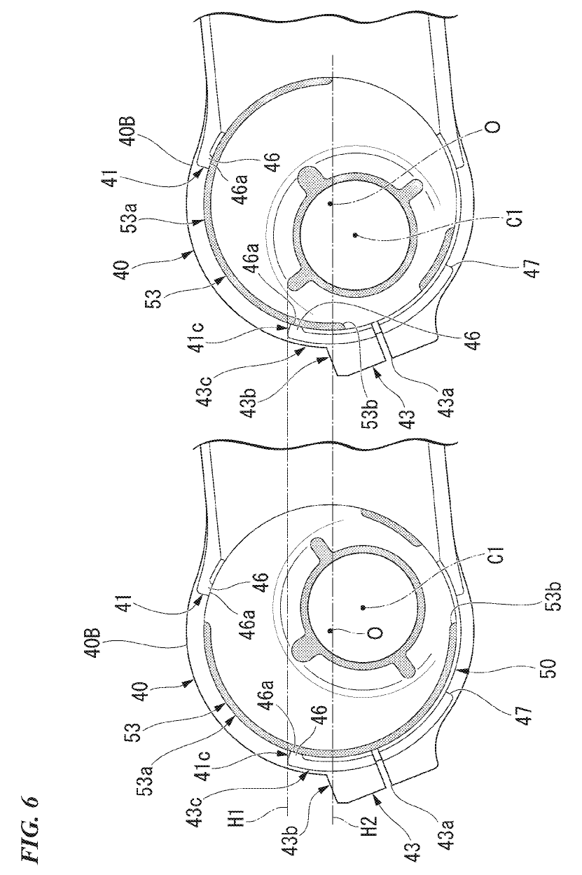

As shown in FIG. 6, the bearing holder 53 has a cylindrical shape and is accommodated within a bearing holder holding portion 40B of the swing arm 40, which will be described later. The bearing holder 53 is fitted into the bearing holder holding portion 40B of the swing arm 40 so as to be pivotable around the cylindrical shaft. The bearing holder 53 holds the bearing 54 at an axial center position C1 to be pivotable eccentrically relative to the swing arm 40. A circular axle insertion hole is provided at the axial center position C1 of the bearing holder 53, and the rear wheel axle 3a is rotatably supported in the axle insertion hole via the bearing.

As shown in FIGS. 2 and 3, a first scale 55 is displayed on a peripheral surface 53a of the bearing holder 53 along the circumferential direction around the axis of the rear wheel axle 3a. The first scale 55 is an indicator stamped on the peripheral surface 53a of the bearing holder 53 so as to be exposed from a slit 41 in the swing arm 40, which will be described later. The first scale 55 is displayed in a region of the peripheral surface 53a that is tilted slightly rearward from the uppermost portion. The first scale 55 is gradated or color-coded at predetermined intervals in the circumferential direction relative to the swing arm 40, and the position of this graduation allows the rotation position of the bearing holder 53, i.e., the position of the eccentric axial center position C1, to be confirmed. By visually checking the first scale 55 in this way, the state of tension of the chain can be easily recognized when adjusting the tension of the drive chain 61.

### Swing Arm 40

As shown in FIG. 1, the swing arm 40 has a cylindrical shape extending forward and backward. A front end portion 40bof the swing arm 40 is supported by a pivot shaft 23 supported on the lower portion of the center frame 18. The swing arm 40 swings upward and downward about the pivot shaft 23. The swing arm 40 is pivotably supported on the vehicle body frame 10 by the pivot shaft 23, and extends rearward from the pivot shaft 23 to rotatably support the rear wheel 3. The swing arm 40 is attached to the internal combustion engine 11 configured to drive the rear wheel 3.

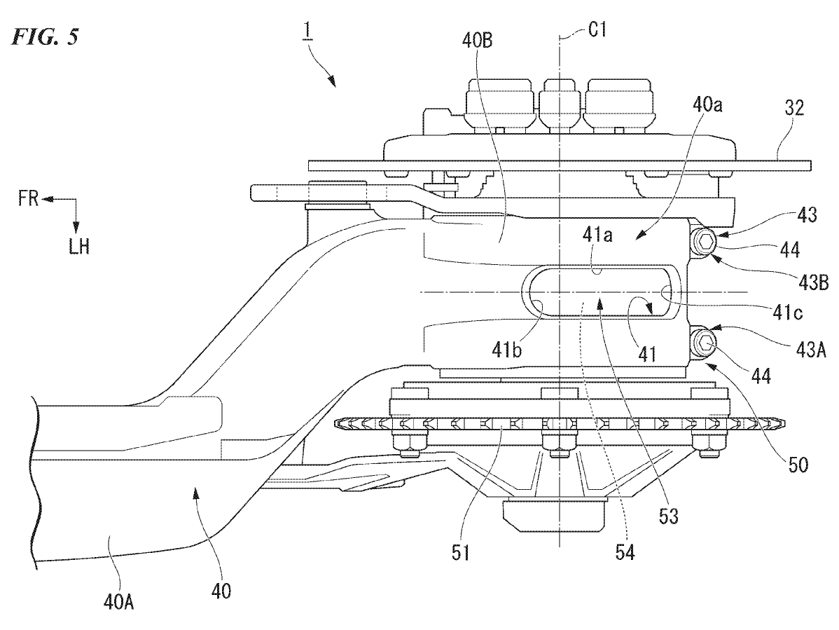

As shown in FIGS. 4 and 5, the swing arm 40 has an arm portion 40A extending from the pivot shaft 23 toward the rear wheel support mechanism 50, and the bearing holder holding portion 40B disposed in front of the rear wheel 3 and having an opening that accommodates the rear wheel support mechanism 50. The swing arm 40 has the arm portion 40A and the bearing holder holding portion 40B integrally formed from the same member.

The arm portion 40A has a pair of rear suspension support portions 40Aa and 40Ab rising from both sides in the vehicle width direction. A portion of an inner side portion of the arm portion 40A in the vehicle width direction facing the tire of the rear wheel 3 has an arc shape that follows the outer shape of the tire and smoothly connects to a rear wall of the bearing holder holding portion 40B in a rear end portion 40a of the swing arm 40. Outer side portions of the pair of arm portions 40A in the vehicle width direction are symmetrical to shapes of inner side portions in the vehicle width direction and have an arc shape that smoothly connects to the rear wall of the bearing holder holding portion 40B. A cross section perpendicular to (intersecting with) the lengthwise direction of the arm portion 40A forms a closed loop.

The bearing holder holding portion 40B has openings on both sides in the vehicle width direction. The bearing holder holding portion 40B has a roughly cylindrical shape with the cylindrical shaft facing in a direction along the rear wheel axle 3a. The bearing holder 53 of the rear wheel support mechanism 50, which has the bearing 54 that rotatably supports the rear wheel axle 3a, is accommodated inside the bearing holder holding portion 40B.

As shown in FIG. 1, the rear wheel 3 is supported by the rear wheel axle 3a provided on the rear end portion 40a of the swing arm 40. A rear suspension 25 is suspended between the rear suspension support portions 40Aa and 40Ab of the swing arm 40 and the vehicle body frame 10.

The rear wheel support mechanism 50 configured to rotatably support the rear wheel axle 3a is attached to the rear end portion 40a of the swing arm 40. The rear wheel axle 3acorresponds to the shaft 30.

### Detailed Structure of Swing Arm

The swing arm 40 has the slit 41 through which the bearing holder 53 faces from an outer side of the rear wheel axle 3a in the radial direction. As shown in FIG. 2 to FIG. 6, the slit 41 passes through the bearing holder holding portion 40B. The slit 41 is located in the middle of the bearing holder holding portion 40B in the vehicle width direction, and is an oblong hole with an upward opening that extends from the upper end position of the bearing holder holding portion 40B diagonally upward toward the rear. The slit 41 is formed from a pair of slit side edge portions 41a extending in the circumferential direction, a slit front edge portion 41b, and a slit rear edge portion 41c.

As shown in FIG. 2 and FIG. 3, the slit 41 is formed at a position where the first scale 55 displayed on the peripheral surface 53a of the bearing holder 53 can be seen from outside the slit 41. That is, the first scale 55 is exposed inside the slit 41. For this reason, the occupant can easily visually check the slit 41 and the first scale 55 from the rear of the vehicle. For this reason, this can be used to adjust the tension of the drive chain 61 (see FIGS. 1 and 2) or to check the slack of the drive chain 61.

The bearing holder holding portion 40B is provided with a second scale 42 to correspond to the first scale 55 around the slit 41. The second scale 42 is displayed on a peripheral wall surface 40d of the slit 41 on the right side in the vehicle width direction. When the rotation position of the bearing holder 53 is adjusted relative to the swing arm 40, the adjustment can be made while checking the first scale 55 seen through the slit 41 and the second scale 42 displayed on the peripheral wall surface 40d of the bearing holder holding portion 40B.

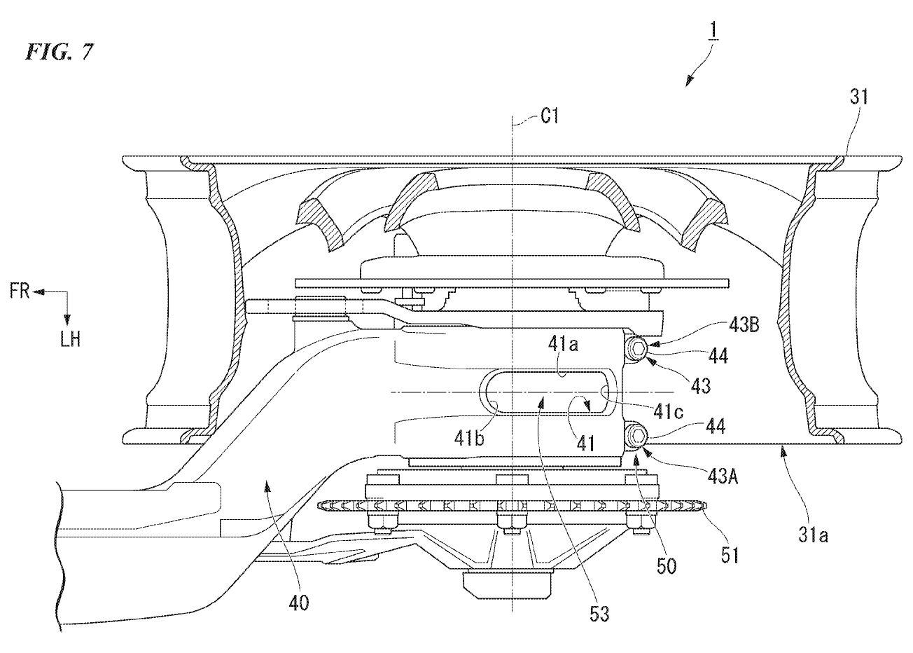

As shown in FIG. 7, the slit 41 is provided inside the rim 31a of the peripheral edge of the wheel 31 in the vehicle width direction.

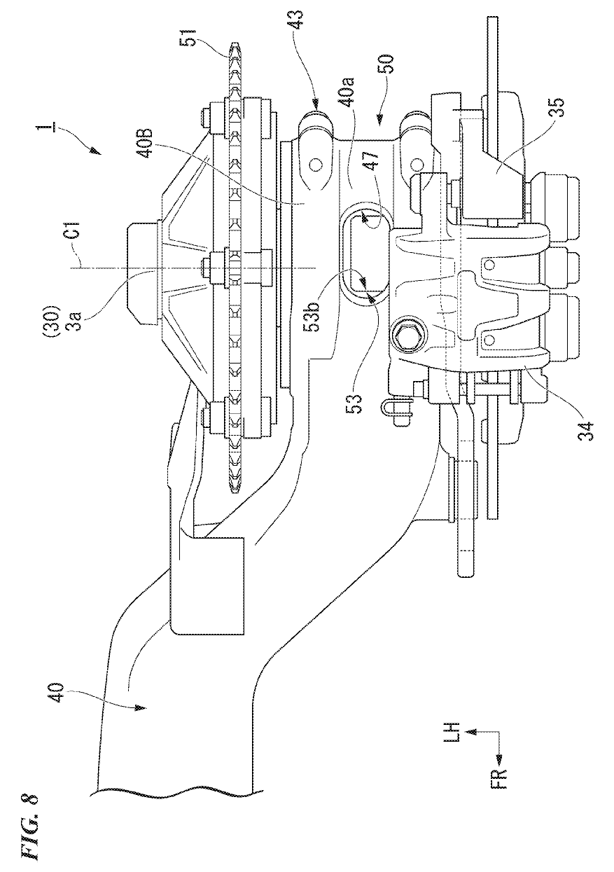

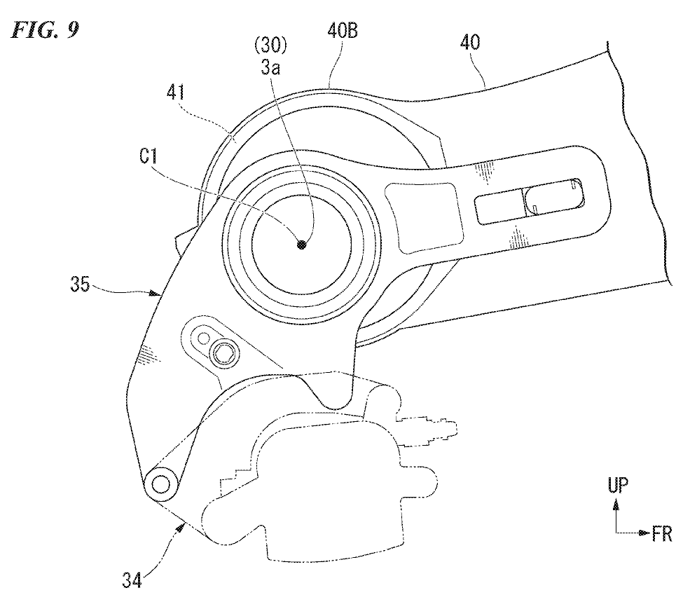

In addition, as shown in FIGS. 8 and 9, the brake caliper 34 is provided within a range below the slit 41.

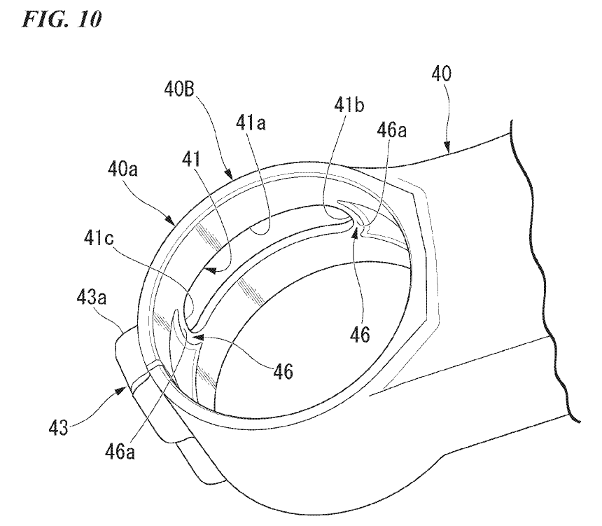

As shown in FIGS. 6 and 10, the opening end portion of the slit 41 has a convex portion 46 for close contact with the peripheral surface 53a of the bearing holder 53. The convex portion 46 is formed by removing a part of the inner surface of the peripheral wall surface 40d of the bearing holder holding portion 40B along the inner periphery at the central portion in the widthwise direction, but the convex portion 46 is continuous with the peripheral wall surface 40d. The slit 41 is an upward opening in communication with the interior of the bearing holder holding portion 40B, and by providing the convex portion 46, a protrusion end 46a of the convex portion 46 can be brought into close contact with the peripheral surface 53a of the bearing holder 53. Accordingly, the opening end portion of the slit 41 adheres closely to the peripheral surface 53a of the bearing holder 53, preventing water or dust from entering a fastening portion (hugging surface) between the swing arm 40 and the bearing holder 53, thereby suppressing biting and instability.

As shown in FIGS. 3, 4 and 6, the swing arm 40 has a clamping portion 43 configured to fix the bearing holder 53. The clamping portion 43 is provided on the rear end side of the bearing holder holding portion 40B of the rear end portion 40a of the swing arm 40. The clamping portion 43 has an opening portion 43athat divides the bearing holder holding portion 40B into upper and lower parts, and an upper piece 43A and a lower piece 43B that face each other vertically at the opening portion 43a are fastened together by a bolt 44. The upper piece 43A and the lower piece 43B each protrude outward from a peripheral wall surface 43c of the bearing holder holding portion 40B in the radial direction. The bearing holder holding portion 40B is configured to be reducible in diameter by a slot 43a. A female thread portion is formed in the lower piece 43B, a bolt hole is formed in the upper piece 43A, and the upper piece 43A and the lower piece 43B are fastened together by inserting the bolt 44 through a bolt hole of the upper piece 43A from above and screwing the bolt 44 into the female thread portion of the lower piece 43B.

An example of adjusting the tension of the drive chain 61 will be described below, in which the rear wheel axle 3a, which is in its most forward position, is moved rearward by a predetermined distance. As shown in FIG. 6, first, after loosening the bolt 44 of the clamping portion 43 to release the clamping of the swing arm 40 to the bearing holder 53, the bearing holder 53 is pivoted clockwise by a predetermined angle, for example, using a spanner or the like.

This pivot causes the axle center (the axial center position C1) of the rear wheel axle 3a to pivot at the same predetermined angle in the clockwise direction around a cylindrical shaft center O of the bearing holder 53, thereby adjusting the wheelbase between the drive sprocket (not shown) and the driven sprocket 51 by a predetermined distance in the forward/rearward direction. That is, it is possible to adjust the tension of the drive chain 61.

As shown in FIG. 2 and FIG. 3, at this time, the pivot alignment of the bearing holder 53 is performed using the first scale 55 displayed on the peripheral surface 53a of the bearing holder 53 and the second scale 42 displayed on the swing arm 40 as a guideline. Then, after the adjustment work of the drive chain 61 is completed, the bolt 44 of the clamping portion 43 is tightened at that position, and the bearing holder 53 is held in position by tightening it to the swing arm 40.

As shown in FIG. 6, an upper end 43b (height position of reference sign H2) of the upper piece 43A of the clamping portion 43 is located below the slit rear edge portion 41c (height position of reference sign H1) of the slit 41. The upper end 43b of the clamping portion 43 is provided above the central axis (the cylindrical shaft center O) of the bearing holder 53. In addition, the upper end 43b of the clamping portion 43 is provided above the axial center position C1 of the rear wheel axle 3a.

As shown in FIG. 3, the peripheral wall surface 40d at the rear end portion 40a (the bearing holder holding portion 40B) of the swing arm 40 has thick portions 40e, which has thickness, in a region extending along the circumferential direction on both sides of the slit 41 in the widthwise direction. The clamping portion 43 is provided in each of the thick portions 40e on both the left and right sides.

As shown in FIGS. 6 and 8, the bearing holder holding portion 40B of the swing arm 40 includes a communication hole 47 in communication with the inside of the swing arm below the bearing holder 53. The bearing holder 53 has a circumferential groove 53b(through-hole) facing the communication hole 47. The communication hole 47 is not connected to the slit 41, so the rigidity of the swing arm 40 is ensured. In this way, by separating the communication hole 47 and the slit 41 and leaving the connection portion, water that enters through the slit 41 can be guided to the communication hole 47 and discharged.

As described above, the motorcycle 1 of the embodiment includes the swing arm 40, the shaft 30 provided on the rear portion of the swing arm 40, the bearing 54 that holds the shaft 30, and the bearing holder 53 that pivotably holds the axial center position of the bearing 54 eccentrically with respect to the swing arm 40. The swing arm 40 is provided with the slit 41 where the bearing holder 53 faces from the outside of the shaft 30 in the radial direction. The bearing holder 53 has the first scale 55 in the circumferential direction that rotates around the axis of the shaft 30. The swing arm 40 is provided with the second scale 42 to correspond to the first scale 55 around the slit 41. The first scale 55 faces from the slit 41.

According to the motorcycle 1 of the embodiment, the slit 41 is provided in the part of the swing arm 40 that holds the bearing holder 53, and by aligning the first scale 55 provided on the bearing holder 53 with the second scale 42 provided around the slit 41, the rotation position can be read visually from the slit 41, making it easy to check the elongation amount of the drive transmission member such as the drive chain 61. In this way, in the embodiment, the first scale 55 is displayed in the circumferential direction of the bearing holder 53, making it easy to see the scale and perform adjustment work, especially when adjusting the eccentric shaft.

In the motorcycle 1, the swing arm 40 has the clamping portion 43 configured to fix the bearing holder 53. The upper end 43b of the clamping portion 43 is provided below the lower end (the slit rear edge portion 41c) of the slit 41.

According to this configuration, since the upper end 43b of the clamping portion 43 is located below the slit 41, loosening and tightening operations can be easily performed without reducing the visibility of the slit 41.

In the motorcycle 1, the upper end 43b of the clamping portion 43 is provided below the central axis of the bearing holder 53.

According to this configuration, since the upper end 43b of the clamping portion 43 is located above the central axis of the bearing holder 53, the clamping portion 43 has good visibility and workability.

In the motorcycle 1, the upper end 43b of the clamping portion 43 is provided above the axial center of the rear wheel axle 3a.

According to this configuration, since the upper end 43b of the clamping portion 43 is located above the axial center position C1 of the rear wheel axle 3a, the clamping portion 43 has good visibility and workability.

The motorcycle 1 further has the wheel 31. The slit 41 may be provided inside the peripheral edge (the rim 31a) of the wheel 31.

According to this configuration, by positioning the slit 41 inside the peripheral edge (the rim 31a) of the wheel 31, the slit 41 is prevented from being exposed to the outside, and the waterproof and dustproof effects inside the swing arm 40 can be improved.

In the motorcycle 1, the swing arm 40 may have the communication hole 47 in communication with the inside of the swing arm 40 below the bearing holder 53, and the bearing holder 53 may have the circumferential groove 53bfacing the communication hole 47.

According to this configuration, the communication hole 47 provided below the swing arm 40 and the circumferential groove 53b provided below the bearing holder 53 can allow the eccentric mechanism part to have a drainage function.

The motorcycle 1 may further have the brake caliper 34, and the brake caliper 34 may be provided within a range below the slit 41.

According to this configuration, since the brake caliper 34 is always disposed below the slit 41, the visibility of the slit 41 can be ensured.

In addition, the motorcycle 1 according to the embodiment has the thick portion 40e in the circumferential direction of the swing arm 40, which has thickness in the circumferential direction. The thick portion 40eis provided with the clamping portion 43.

According to this configuration, increasing the rigidity of the thick portion 40e of the clamping portion 43 can prevent performance deterioration. Further, the bolt 44 used for fastening can be disposed in the thick portion 40e with high rigidity, and in combination with the bolt axial force, the bearing holder 53 can be held efficiently and securely.

The present invention is not limited to the above-mentioned embodiment, and for example, the structure of the embodiment may be applied to a saddle riding vehicle other than a motorcycle. The term “saddle riding vehicle” includes all vehicles in which

the driver straddles the vehicle body, including motorcycles (including mopeds and scooter-type vehicles), as well as vehicles with three wheels (including vehicles with one front wheel and two rear wheels, as well as vehicles with two front wheels and one rear wheel) or four wheels (such as four-wheeled buggies). In addition, this includes not only scooter-type vehicles with a straddle space, but also vehicles with a straddle section. It may also be applied to vehicles that include an electric motor as a prime mover.

The present invention may be applied to various types of reciprocating engines, such as single-cylinder engines, parallel or V-type multiple-cylinder engines, and longitudinally mounted engines with the crankshaft aligned with the vehicle forward/rearward direction.

Then, the configuration of the embodiment is an example of the present invention, and various modifications are possible without departing from the spirit of the present invention, such as replacing the components of the embodiment with well-known components.

### BRIEF DESCRIPTION OF THE REFERENCE SYMBOLS

1 Motorcycle (saddle riding vehicle)

2 Front wheel

3 Rear wheel

3a Rear wheel axle

10 Vehicle body frame

11 Internal combustion engine

23 Pivot shaft

30 Shaft

31 Wheel

31a Rim

34 Brake caliper

35 Brake bracket

40 Swing arm

40a Rear end portion

40b Front end portion

40d Peripheral wall surface

40e Thick portion

40A Arm portion

40B Bearing holder holding portion

41 Slit

42 Second scale

43 Clamping portion

43a Opening portion

43b Upper end

46 Convex portion

47 Communication hole

50 Rear wheel support mechanism

51 Driven sprocket

53 Bearing holder

53a Peripheral surface

53b Circumferential groove (through-hole)

54 Bearing

55 First scale

61 Drive chain

What is claimed is:

1. A saddle riding vehicle comprising:
a swing arm;
a shaft provided on a rear portion of the swing arm;
a bearing configured to hold the shaft; and
a bearing holder configured to pivotably hold an axial center position of the bearing eccentrically with respect to the swing arm,
wherein the swing arm is provided with a slit where the bearing holder faces from the outside of the shaft in a radial direction,
the bearing holder has a first scale in a circumferential direction that rotates around an axis of the shaft,
the swing arm is provided with a second scale to correspond to the first scale around the slit, and
the first scale faces from the slit.

2. The saddle riding vehicle according to claim 1, wherein the swing arm has a clamping portion configured to fix the bearing holder, and
an upper end of the clamping portion is provided below a lower end of the slit.

3. The saddle riding vehicle according to claim 2, wherein an upper end of the clamping portion is provided above a central axis of the bearing holder.

4. The saddle riding vehicle according to claim 2, wherein an upper end of the clamping portion is provided above an axial center of the shaft.

5. The saddle riding vehicle according to claim 1, further having a wheel,
wherein the slit may be provided inside a peripheral edge of the wheel.

6. The saddle riding vehicle according to claim 1, wherein the swing arm has a communication hole communicating with the inside of the swing arm below the bearing holder, and
the bearing holder has a through-hole facing the communication hole.

7. The saddle riding vehicle according to claim 1, further having a brake caliper,
wherein the brake caliper is provided within a range below the slit.

8. The saddle riding vehicle according to claim 2, having a thick portion in a circumferential direction of the swing arm, which has thickness in the circumferential direction,
wherein the thick portion is provided with the clamping portion.
